(19) United States
(12) Patent Application Publication
(10) Pub. No.: US 2006/0178766 A1
(43) Pub. Date: Aug. 10, 2006

(54) Method and apparatus for copying data from recordable media directly to portable storage devices

(75) Inventors: Sanford B. Schupper, Monrovia, CA (US); Carrie A. Schupper, New York, NY (US)

Correspondence Address: BINGHAM MCCUTCHEN LLP, 3000 K STREET, NW, BOX IP, WASHINGTON, DC, 20007, US

(73) Assignee: Wingspan Investment Partners I, LLC

(21) Appl. No.: 11/349,973

(22) Filed: Feb. 9, 2006

Related U.S. Application Data
(60) Provisional application No. 60/651,168, filed on Feb. 9, 2005.

(51) Int. Cl. G06F 17/00

(52) U.S. Cl. 700/94

(57) ABSTRACT

A method and apparatus for copying data from a recordable media to a portable storage device is disclosed. The apparatus includes a copying device comprising a processor, a memory, and a user interface. The processor is preferably a dual core processor that is capable of dividing the tasks to be performed, and executing them substantially simultaneously. Using the disclosed apparatus, transferring files from the recordable media to the portable storage device may be achieved at greater than real time play rates. When audio files are stored on the recordable media, the apparatus is capable of transferring the audio files, including track information, to the portable storage device.

### CROSS-REFERENCE TO RELATED APPLICATIONS

The present invention claims priority to provisional Patent Application No. 60/651,168, filed Feb. 9, 2005, the entirety of which is incorporated herein by reference.

### FIELD OF THE INVENTION

The present invention generally relates to a method and apparatus for copying and playing music or audio files. More specifically, the present invention relates to a method and apparatus for copying digital data from a compact disk onto a portable storage device without the use of a standalone computer.

### BACKGROUND OF THE INVENTION

Over the past ten years, the investment in digital technology has increased significantly. The increased investment has led to the invention of new types of memory. These advances have also resulted in memory that has increased capacity, which allows a greater amount of data to be stored in a given amount of memory. More recently, many companies have taken advantage of advances in memory technology and high quality compression protocols, such as the MP3 format, to develop portable storage devices that are capable of playing music or displaying video.

Typically, portable devices or players are in high demand because of their very small size and large storage capacity, with a device less than a third the size of a typical compact disk (CD) player being able to store and play hundreds or thousands of audio files e.g., songs. A number of data compression formats have been developed to support storing such a large number of audio files on these devices. For example, MP3 is a popular audio-compression format that provides an efficient audio-coding scheme that allows compression of audio files by a factor of up to 12 with little loss in quality. This and other compression techniques are implemented by portable player manufacturers, such as Apple Computer, Inc. in their iPod devices, to allow a user to store and listen to many hours of music or audio programs while they are mobile.

The use of portable players that play compressed audio files is much more convenient than carrying bulkier CD players and, of course, numerous CDs and/or CD cases. However, the use of these portable players is generally limited to people who also own a personal computer or other computing device, which significantly reduces the pool of potential users. This limitation exists because presently there is no way to get music along with other data, such as full track, album, artist, and/or description information, onto a portable player, such as an iPod or other MP3 or similar player, without the use of a computer. Specifically, owners of portable storage devices are required to load their CD collection onto a computer before transferring the music to the portable storage device.

### SUMMARY OF THE INVENTION

The present invention addresses the above and other problems by providing a method and a data file transferring device that eliminates the requirement for loading data onto a computer prior to copying the data to a portable player. The data may include, but is not limited to, one or more of audio, video, and text or any combination thereof. Briefly, a recordable media is placed in a copying device, the device is connected to a portable storage device, and data from the recordable media is appropriately transferred onto the portable player without the use of a personal computer. With the inventive device, iPod and other MP3 player owners can conveniently transfer data to their portable devices without connecting the portable device to a computer. One advantage of the present invention is that a non-computer owner can now purchase an iPod or other player and transfer data from recordable media onto it. Further, the present invention preferably provides a convenient way to load data on to their portable devices. Optionally, the present invention allows the transfer of data from one portable device to another portable device.

The copy or transfer device of the present invention is embodied as a recordable media reader with a CPU and embedded firmware that along with application and utility software is used to transfer or copy music or data from recordable media directly to a portable device without the need of a desktop, laptop, or other stand-alone computer system. Track information, normally not present on a Compact Disk, can be loaded onto the portable device along with each data file using a database and software embedded within the copy device that matches each data file with its track information. This track information may displayed on both the copying device and the portable storage device. In one embodiment, the copy or transfer device runs the embedded firmware with an embedded Linux operating system. However, any operating system known to those skilled in the art may be used as desired. The firmware or software that performs the data transfer and other functions described herein may be written in the C programming language or other useful programming language and compiled by the processor included in the copying device.

According to one aspect, the present invention comprises a method for transferring data from a recordable media to a portable storage device using a copying device. The method includes reading the content of the recordable media and converting the content of the recordable media from a first format to a second format. The content in the second format may then be transferred from the copying device onto the portable storage device. In one embodiment of the present invention, the content in the second format includes track information. The track information may comprise at least one of title information, artist information, and track duration.

In one embodiment, it may be desirable for the reading, converting, and transferring to occur at a greater than real time play rate. Preferably, the greater than real time play rate comprises at least twice the real time play rate. More preferably, the greater than real time play rate comprises at least ten times the real time play rate. This may be achieved, for example, by performing the reading and converting substantially simultaneously. In one embodiment, reading the recordable media includes determining a media ID and matching the content on the recordable media with track information from a database embedded within the copy device based on the media ID.

According to another aspect, the present invention includes a method for copying data onto a portable storage device. The method comprises reading data from a recordable media using a copying device. The data is then converted from a first format to a second format, and the data in the second format may subsequently be transferred from the copying device onto the portable storage device at a greater than real time play rate. The greater than real time rate preferably comprises at least twice the real time play rate, and more preferably comprises at least five times the real time play rate. In one embodiment, the reading, converting, and transferring are performed on separate processor cores. Preferably, the reading comprises determining track information related to the data.

In yet another aspect of the present invention, an apparatus for transferring data from a recordable media to a portable storage device is disclosed. The apparatus includes a copying device capable of receiving a recordable media. The copying device preferably includes a processor, a memory, and a user interface. It is desirable for the memory to include an operating system and at least one software program loaded thereon. Also included is a portable storage device capable of storing data in the digital format. It is desirable for the copying device to be capable of reading data from a recordable media, converting the read data into another format, and transferring the data onto the portable storage device at greater than real time play rates.

Preferably, the processor comprises a dual core processor. Each core of the processor works substantially simultaneously to perform the reading, converting, and transferring. The apparatus may also include a database having track information. Thus, when the data comprises audio files, they may be transferred from the recordable media having the data file to the portable storage device with track information. Preferably, the audio files and their corresponding track information is determined based on a media ID for the recordable media. The files may be transferred at a rate that is at least twice the real time play rate. The audio files may be transferred to the portable storage device in the MP3 format. Examples of portable storage devices include at least one of an iPod, a USB external drive, and a Flash Disk.

### BRIEF DESCRIPTION OF THE DRAWINGS

Further features and advantages of the invention can be ascertained from the following detailed description that is provided in connection with the drawings described below:

FIG. 1 is a block diagram showing one embodiment of the present invention; and

FIG. 2 is a flow chart showing exemplary steps according to one embodiment of the present invention.

### DETAILED DESCRIPTION OF THE PREFERRED EMBODIMENTS

Until now, a user who wanted to transfer data from a recordable medium, e.g., a CD, onto a portable storage device, e.g., an iPod, was required to first transfer the data from the CD onto a standalone computer, which would then transfer the data to the portable storage device. Besides the obvious waste of time that this process presents to a user, considerable expense is required to purchase a standalone computer, which can cost up to a couple thousand dollars or more. In order to eliminate the intermediate step of transferring data from a CD to a standalone computer, the present invention allows data to be transferred directly from a CD onto a portable storage device.

The present invention provides a method and apparatus that is capable of transferring data from a recordable media onto a portable storage device. Preferably, the recordable media may include any media capable of storing data in a digital format. The recordable media may include, but is not limited to, CD's, DVD's, SD cards, SIM cards, memory sticks, optical disks, EPROM's, and the like. Moreover, the recordable media may include any type or combination of data including, but not limited to, audio, video, or textual information. Although the present invention described herein may be described to a particular recordable media, e.g., CD's, or a particular type of data, e.g., audio, it will be understood these are just examples used for illustrative purposes only. As such, the present invention is not intended to be limited to any particular type of recordable media or data. Those skilled in the art will appreciate that the present invention may be modified to accommodate any type of recordable media or data.

Music files are typically stored on CD's in the .CDA or .WAV format, whereas portable storage devices typically use a compressed audio format such as MP3 or the like. The present invention is capable of converting files between two or more formats, as described below. Moreover, when audio files are being transferred from a CD onto a portable storage device, music and track information e.g., author, title information, album information, and duration, are preferably transferred as well. This information may be displayed on the copying device, the portable storage device, or both.

According to one aspect, the present invention comprises a copying device that includes the ability to play CD's that include at least one of video, audio, or textual data. As such, any type of CD known to those skilled in the art may be used. The copying device is preferably capable of transferring the data from a CD onto a portable storage device. Because CD's and portable storage devices often store data in different formats, the copying device is preferably capable of converting the files from the CD into another format that is compatible with the storage device.

Any type of portable storage device known to those skilled in the art may be used. The portable storage device is preferably capable of storing data in the digital format, e.g., MP3 or the like. Portable storage devices may be capable of storing and playing and/or displaying audio, video, or textual information. One example of a portable storage device that may be used is an Apple iPod. Other examples of portable storage devices include USB external drives or flash disks.

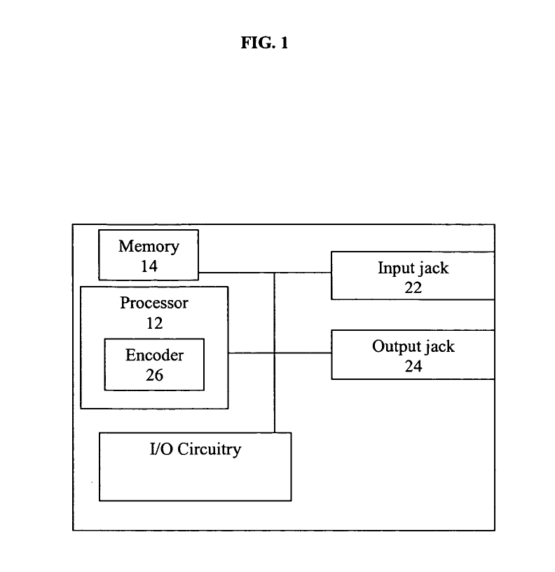

FIG. 1 is a block diagram showing one embodiment of the present invention. In one embodiment, the copying device of the present invention comprises a CD player 10. The CD player 10 preferably includes a processor 12, a memory 14, input and output circuitry including input devices 16, a display 18, a recordable media reader (not shown), input 20 and output 22 jacks, and the like. The processor 12 may include one or more encoders 26 that convert data from one format to another. Preferably, the copying device uses an operating system and software configured to facilitate the copying of files from the recordable medium to the portable storage device.

Any type or size of memory 14 known to those skilled in the art may be used. The memory may include, for example, read-only memory (ROM) and random-access memory (RAM). Different types of RAM and ROM may be used, such as flash memory, dynamic RAM, static RAM, and the like. Additionally, any type of input devices may be used, such as a keyboard, buttons, touch sensitive displays, or the like. A display 18 may also be included to allow a user to view which data file is being read and/or copied, and to allow the user to interact with the copying device. The display 18 may include one or more LED's, a LCD, and the like. Further, the present invention includes input and output jacks that allow the copying device to be operatively connected to the portable storage device using a wire or other type of transfer medium, such as a USB port, serial port, parallel port, and the like. Optionally, the copying device and the portable storage device may communicate wirelessly, via the radio frequency (RF) spectrum, infrared (IR) spectrum, and the like.

The processor 12 is preferably capable of running an operating system, such as a modified version of the Linux operating system. The operating system may in turn be used to run software programs that allow data to be read from a CD, converted to another format, and transferred to a portable storage device. The present invention is not intended to be limited to any type of software, and those skilled in the art will understand that a variety of operating systems and software programs may be used as desired according to a particular application.

In one embodiment, the processor may comprise a central processing unit (CPU) or the like. The processor is preferably a single core processor. More preferably, the processor is a dual core processor. In other embodiments, a processor comprising more than two cores may be used. Or, two or more separate processors may be used in alternate embodiments.

As mentioned above, the present invention preferably includes a dual core processor. According to one aspect, the dual core processor provides the advantage of allowing data to be transferred from a CD to the portable storage device at greater than real time rates. For example, the present invention preferably converts data from a CD into a data format that can be transferred onto a portable storage device. Typically, data on a CD is stored in the .CDA format, while data stored on a portable storage device is stored in the MP3 format. Thus, in order to transfer data from a CD onto a portable storage device, it is desirable to convert the data from the .CDA format to the MP3 format. Once the conversion of the data is complete, it can be transferred onto the portable storage device.

The process of converting data between formats and then transferring the files onto a portable storage device is preferably expedited using the dual core processor, such as the dual core BlackFin 561 processor manufactured by Analog Devices. As such, it is desirable for each core of the dual core processor to be used to simultaneously to perform the same or different tasks. For instance, in one embodiment a main software application runs on the first processor core and the MP3 encoder application runs on the second processor core. This separation of tasks allows for a more efficient usage of the processor. Thus, the main software application on the first core can read data and write data to the portable storage device while the second core can encode the song data from the .CDA format to the MP3 format. Using two processors to divide the tasks of conversion and transferring allows data to be transferred from the CD to the portable storage device at greater than real time rates. Of course, this is just an example of one way that the processes may be divided among the two cores of the processor. The two cores of the processor do not have to perform completely different tasks. Rather, in alternate embodiments each core of the processor may perform the same or partially overlapping tasks, as desired according to a particular application.

In one embodiment, the dual core processor uses a shared memory configuration to transfer and receive files from the encoder, which may be included in the second core. It may be desirable for a software program to handle the scheduling of memory access between the first core and the second core. For instance, for each separate data file the software program directs the desired core to wait for the memory to be full. The encoder encodes from the memory by writing out the MP3 data back to another part of the memory. Each part of the memory is marked when it is full, preventing further data from being written to that part of the memory. Preferably, the software program receives an end of file (EOF) instruction when the encoding of a particular file is complete. In the event that there is too little or too much data for the memory being shared between the cores in the processor, the encoder manages the data and has the ability to start and stop as data becomes available to, and is converted by, the encoder.

As mentioned above, the present invention is capable of transferring data from the CD to the portable storage device at greater than real time rates. Preferably, the present invention transfers data from a CD to a portable storage device at a rate that is at least about twice the real time play rate. More preferably, the present invention transfers data from a CD to a portable storage device at a rate that is at least about five times the real time play rate. Most preferably, the present invention transfers data from a CD to a portable storage device at a rate that is at least about 10 times the real time play rate. In another embodiment, the present invention transfers data from a CD to a portable storage device between about 1 and about 40 times the real time play rate. More preferably, the present invention transfers data from a CD to a portable storage device at between about 3 and about 25 times the real time play rate. Most preferably, the present invention transfers data from a CD to a portable storage device at between about 5 and about 20 times the real time play rate.

The present invention also includes a database stored in the memory of the copying device. It is desirable for the database to include identifying information, e.g., track information, regarding a plurality of data files. The track information may include, but is not limited to, titles, track list, album information, recording artists, and duration. The track information may be loaded onto the database as part of the manufacturing process. Because new data files are constantly being released, the database may require periodic updating. The periodic updating of the database may be accomplished in any desired manner. In particular, the database may be updated through the use of a CD that includes updated track information about data files released after the initial uploading of the database during the manufacturing process. Alternately, the database may be updated by connecting the copying device to the internet, through the use of a hardwire connection, e.g., a phone line, USB port, serial port, parallel port, or the like. Alternately, the copying device may be connected to the internet via a wireless connection operating in the radio-frequency (RF) or infrared (IR) spectrum. By selecting an option from a menu visible via the display, a software program may be instructed to connect to a predetermined IP address, such as the Compact Disk Database (CDDB), which can then update the database included in the copying device. As skilled artisans will recognize, this is just one example of the way track information may be determined for a given CD and is not intended to limit the present invention.

For example, according to another aspect the present invention uses the “freedb” database, which is a free database that includes track information for audio CD's, and is accessible at www.freedb.org. The freedb database identifies data files and their corresponding track information using a unique “media ID.” Though many variations are possible, in one embodiment the media ID comprises an 8-digit hexadecimal number that is computed using data from a CD's table of contents in minute second frame (MSF) form. Thus, when a audio CD is inserted, the media ID is calculated and the CD label, title information, and track information is displayed to the user to enable them to select data on the CD. Once the data are displayed, a user may select the data that they want to be recorded to the portable storage device. After selecting the data to be transferred to the portable storage device, the audio data may be automatically transferred.

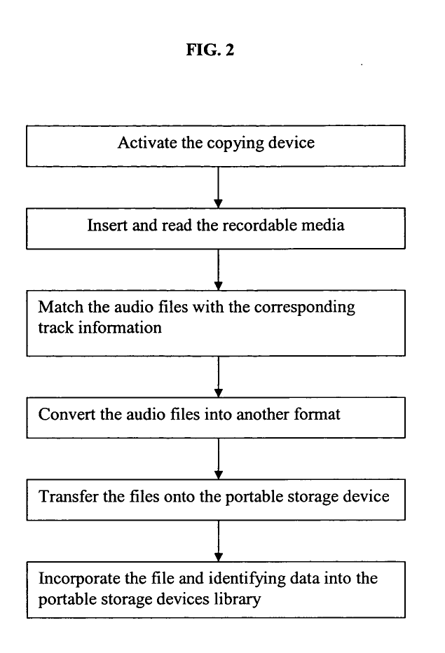

FIG. 2 is a flow chart showing one embodiment of the method of the present invention. According to the method of the present invention, the copying device is first activated by depressing a power button, or selecting the power function from a touch sensitive display. When the device is activated, the operating system will boot, and one or more LED's may selectively activate to indicate that the device is in the booting process. After the device has been activated, a CD may be inserted into the media reader. If the CD is read properly, the number of files, e.g., songs on the CD is preferably displayed.

In embodiments where a music CD is inserted into the copying device, the present invention preferably determines that the CD includes audio files, e.g., by identifying the format of the files. Once the present invention determines that audio files are present on the CD, a software program is preferably initiated to determine the CD's media ID, as described above. Once the media ID is determined, the software program preferably matches the music files with the appropriate track information obtained from the embedded database, which aids the user in identifying the data on the CD. Occasionally, a CD's media ID may not match with any of the track information stored in the database. This may occur, for example, if the CD's track information is not stored in the database. In such an event, the present invention preferably indicates that no match is found. According to one embodiment, the user may still select data to be copied onto the portable storage device, however they will be copied without the track data. Alternately, the user may insert a data CD into the copying device to update the database. Or, the user may eject the music CD if they opt not to copy the music files without track information. Optionally, the present invention may include a keypad that enables a user to manually enter track information for each data file. This may be accomplished, for example, if the user reads the track information off of a CD cover and then manually enters the desired information for each track.

The portable storage device may be operatively connected to the copying device before, during, or after activation. If the portable storage device and the copying device are capable of wirelessly transmitting and receiving data, no hardwire connection may be necessary. Regardless of whether the portable storage device is hardwired or wirelessly connected to the copying device, the operating system preferably runs software that is capable of recognizing the device. When the devices are operatively connected, either through hardwire or wireless connection, the storage device preferably communicates with the portable storage device in order to locate a directory where the data may be transferred. In embodiments where the portable storage device comprises an iPod, the copying device preferably searches for the iPod control folder. If the control folder, or other file storage directory is located, the copying device preferably alerts the user using the display or other visual cue, e.g., LED's and the like.

Once the directory to which data can be transferred is located, the copying device preferably displays the data on the CD, e.g., the audio files and their track information, and provides the user with several options. For instance, the user may have the option to copy the entirety of the data on the CD onto their portable storage device. If this is desired, the user may select the copying function that corresponds to the copying of all of the tracks on the CD. Any method or apparatus known to those skilled in the art may be used to select the copying function. This may include, for example, depressing a button, moving a switch, or selecting an option on a touch sensitive screen. If it is desirable to copy the entire contents of a CD onto a portable storage device, the present invention is configured such that this function may be initiated and completed through a unitary action of the user, e.g., selecting a copy function. As such, it may be desirable for the default setting to have each of the data files on the CD automatically selected for copying after the CD is inserted.

Often, however, a user prefers to select only certain files from a CD for copying onto their portable storage device. In such an embodiment, a user may select the desired files for transferring to the storage device. According to one aspect, once a data file is selected and confirmed for copying the present invention may automatically begin the conversion and copying of the data file. Alternately, one or more data files may first be selected. Then, once all of the desired data files from a particular CD have been selected, the conversion and copying may be initiated. If the entirety of the data files on the CD are automatically selected for copying, it may be necessary for a user to “deselect” the files which they do not want to be copied onto the storage device.

Once the desired data files have been selected for copying, the copying device preferably runs a software program that reads the data files from the CD, converts them into a format compatible with the portable storage device, and transfers them to the storage device. The apparatus and method of reading, converting, and copying the device is described above with respect to the processor.

The method of the present invention is not limited to the particular order described above. Rather, the steps may be varied as desired. For example, the data files on the CD may be read before the portable storage device is operatively connected to the copying device. Or, the files on the CD may be stored into the memory included in the copying device, but not converted to another format, before a user selects data files to be copied to the portable storage device. In another embodiment, the files on the CD may be read, converted, and then stored in the memory included in the copying device. Of course, these are just examples of the possible variations of the method of the present invention. Those skilled in the art will appreciate that many variations of the method described above may be desired according to a particular application.

According to another aspect of the present invention, the copying device is capable of transferring data between two or more portable storage devices. In this configuration, the two portable storage devices are preferably operatively connected to the copying device in the manner described above. Once the two portable storage devices are operatively connected to the copying device, the operating system recognizes the connection and prompts the user to designate one of the storage devices as the source, and one as the destination. Then, a software program may be run to read the data files on the storage device. A user may then select the data files that they wish to transfer onto the destination device. Of course, if the two devices include data stored in the same format, no conversion between formats is necessary. However, the present invention is capable of determining, using a software program, if the file formats of the two devices are compatible. If they are not, the copying device preferably initiates the conversion and transfer functions described above.

According to another aspect, the present invention may be used to transfer data from a satellite or cable receiver directly onto a portable storage device. In this aspect, the copying device may be operatively connected to both the satellite or cable receiver and the portable storage device. The cable or satellite receiver may be operatively connected to the copying device via a RCA connector, S-Video, coaxial cable, or a universal service bus (USB) cable. Then, the data from the satellite or cable receiver may be read by the copying device. If the format of the data stored on the satellite or cable receiver is different than the format of the portable storage device, the files may be converted into the appropriate format. Then, the data files may be transferred onto the portable storage device at greater than real time play rates. In one embodiment, the copying device may include a database that includes information about the movies, shows, videos, or text that is downloaded by the cable or satellite receiver. This allows the present invention to display the name of the shows for a user to view. Alternately, the information about the data from the cable or satellite receiver may be included when the show is transferred onto the copying device. One advantage of this aspect of the present invention is that data, e.g., movies, television shows, music videos, and text, may be transferred from a satellite or cable receiver without the need for a standalone computer. Another advantage of this aspect is that the data from the satellite or cable receiver may be transferred at greater than real time play rates.

Although the present invention has been described with reference to particular embodiments, it will be understood to those skilled in the art that the invention is capable of a variety of alternative embodiments within the spirit of the appended claims.

1. A method for transferring data from a recordable media to a portable storage device, comprising:
reading the content of the recordable media using a copying device;
converting the content of the recordable media from a first format to a second format; and
transferring the content in the second format from the copying device onto the portable storage device;
wherein the content in the second format includes track information from a database included in the copying device;
and wherein at least two of the reading, converting, and transferring can occur at the same time.

2. The method according to claim 1, wherein the reading, converting, and transferring occurs at a greater than real time play rate.

3. The method according to claim 1, wherein the track information comprises at least one of title, artist information, and track duration.

4. The method according to claim 2, wherein the greater than real time play rate comprises at least twice the real time play rate.

5. The method according to claim 2, wherein the greater than real time play rate comprises at least ten times the real time play rate.

6. The method according to claim 1, wherein the reading and converting occur substantially simultaneously.

7. The method according to claim 1, wherein the reading comprises:
determining a media ID; and
matching the content on the recordable media with track information from a database based on the media ID.

8. A method for copying data onto a portable storage device, comprising:
reading data from a recordable media using a copying device;
converting the data from a first format to a second format; and
transferring the data in the second format from the copying device onto the portable storage device;
wherein the reading, converting, and transferring occurs at a greater than real time play rate.

9. The method according to claim 8, wherein the greater than real time play rate comprises at least twice the real time play rate.

10. The method according to claim 8, wherein the greater than real time play rate comprises at least five times the real time play rate.

11. The method according to claim 8, wherein at least one of the reading, converting, and transferring is performed on a separate core of a processor.

12. The method according to claim 8, wherein the data comprises audio files, wherein the reading comprises determining track information for each of the audio files.

13. An apparatus for transferring data from a recordable media to a portable storage device, comprising:
a copying device capable of receiving a recordable media, the copying device including a processor, a memory, and input/output circuitry;
a portable storage device capable of storing data in the digital format;
wherein the copying device is capable of reading data from a recordable media, converting the read data into another format, and transferring the data onto the portable storage device at greater than real time play rates.

14. The apparatus according to claim 13, wherein the processor comprises a dual core processor.

15. The apparatus according to claim 14, wherein each core of the processor works substantially simultaneously to perform the reading, converting, and transferring.

16. The apparatus according to claim 13, further comprising a database having track information.

17. The apparatus according to claim 16, wherein the data comprises files, wherein the files are transferred to the portable storage device with track information.

18. The apparatus according to claim 13, wherein the greater than real time play rates comprises at least twice the real time play rate.

19. The apparatus according to claim 17, wherein the audio files and their corresponding track information is determined based on a media ID.

20. The apparatus according to claim 17, wherein the audio files are transferred to the portable storage device in the MP3 format.

21. The apparatus according to claim 13, wherein the portable storage device comprises at least one of an iPod, a USB external drive, and a flash disk.

22. The apparatus according to claim 13, wherein the memory includes an operating system and at least one software program loaded thereon.
